(19) United States
(12) Patent Application Publication
(10) Pub. No.: US 2016/0267230 A1
(43) Pub. Date: Sep. 15, 2016

(54) TOUCHLESS PROCESSING

(71) Applicant: Passport Health Communications, Inc., Franklin, TN (US)

(72) Inventors: Michael Peter Ochs, Franklin, TN (US); Edmond Chase Pilkington, Rockvale, TN (US); Gregory Scott MacKenzie, Nashville, TN (US)

(73) Assignee: Passport Health Communications, Inc., Franklin, TN (US)

(21) Appl. No.: 14/656,912

(22) Filed: Mar. 13, 2015

(51) Int. Cl. G06F 19/00; G06F 3/041

(52) U.S. Cl. CPC G06F 19/328; G06F 3/041

(57) ABSTRACT

Identification of data discrepancies in patient encounter information and automatic resolution of identified data discrepancies without user intervention is provided. The touchless processing system identifies data discrepancies between patient encounter information and one or more transaction processing outcomes, determines which data discrepancies can be resolved without user intervention, automatically resolves the identified data discrepancies according to a set of rules, and posts relevant information associated with the data discrepancy resolution to a healthcare provider information system.

### BACKGROUND

In an effort to ensure patient information is accurate, payer requirements are met, and payments for healthcare services are collected, most healthcare providers collect various pieces of information from a patient, and perform (or use an intermediary service to perform) various processes during a patient registration or preregistration process, for example, preauthorization, precertification, insurance verification, demographic information verification, a credit score inquiry, etc. Results from the processes are typically provided to a healthcare administrative user electronically via an application interface. The healthcare administrative user may either have to manually examine the results, interpret the data, and compare the results with the information provided by the patient for discrepancies, or may use an automated system for identifying discrepancies and alerting the user.

Even with an automated system, the healthcare administrative user must analyze the discrepancies and determine what steps to take to resolve or clear the issue. This technique suffers from the drawback that resolving discrepancy issues is not automatic. For example, because human intervention is required to clear discrepancy issues, clearing a patient through registration is oftentimes inefficient, and a healthcare administrative user's patient registration throughput is negatively affected. Additionally, depending on the user's experience, training, workload, and other factors, discrepancies may not be resolved appropriately. Accordingly, problems can arise when the healthcare provider tries to collect payment for services. It is with respect to these and other considerations that the present invention has been made.

### BRIEF SUMMARY

Identification of data discrepancies in patient encounter information and automatic resolution of identified data discrepancies without user intervention is provided. Various aspects of a touchless processing system parse relevant information from registration data associated with a patient healthcare encounter, compare the parsed information against outcomes of one or more transaction processes to identify data discrepancies, compare identified data discrepancies against a set of rules used to determine whether an identified data discrepancy in the patient encounter information can be resolved without user intervention, and automatically resolve the data discrepancy that is identified as resolvable without user intervention.

Additionally, aspects of the touchless processing system automatically post relevant patient data to a healthcare information system once the identified data discrepancy is resolved. An indication of discrepant data for which user intervention is needed based on the results of the determinations by the touchless processing system is provided in an application interface, such that a user is able to address and resolve identified data discrepancies to ensure correct patient information and to ensure accurate information for downstream patient access workflow processes. The user is presented with only the cases that need user intervention. By automatically resolving data discrepancies and posting cleared patient information to the healthcare information system without user intervention, a more efficient, accurate, and productive workflow is provided. For example, costly denials and write-offs as a result of human error is decreased and the efficiency of processing of registration data is increased, thus resulting in increased patient registration output.

### BRIEF DESCRIPTION OF THE DRAWINGS

Further features, aspects, and advantages of the invention represented by the examples described present disclosure will become better understood by reference to the following detailed description, appended claims, and accompanying Figures, wherein elements are not to scale so as to more clearly show the details, wherein like reference numbers indicate like elements throughout the several views, and wherein:

FIG. 1 illustrates one example of the touchless processing system;

FIG. 2 illustrates one example of the touchless processing engine;

FIGS. 3A and 3B illustrate a high level flowchart of one example of a touchless processing method;

FIG. 4 is a simplified block diagram illustrating example physical components of a computing device with which aspects of the system may be practiced.

### DETAILED DESCRIPTION

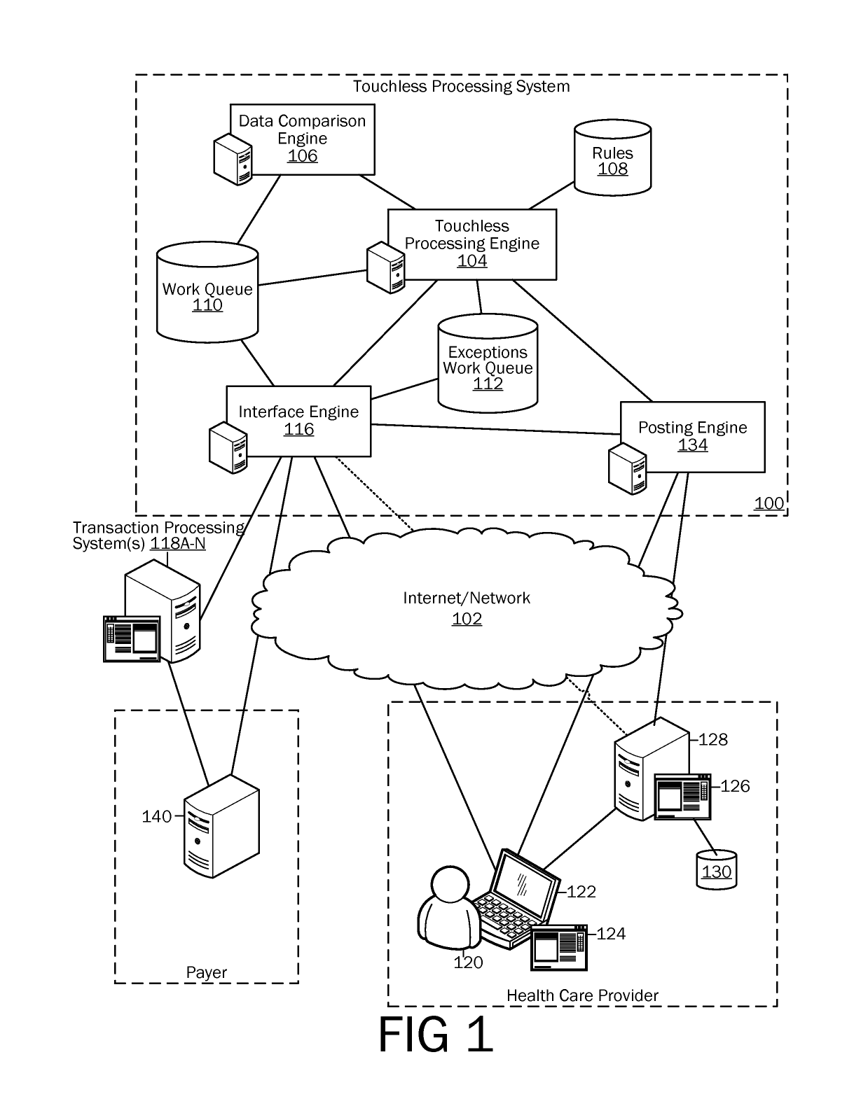

A touchless processing system is described herein and illustrated in the accompanying figures. The touchless processing system identifies data discrepancies between patient encounter information and one or more transaction processing outcomes, determines which data discrepancies can be resolved without user intervention, automatically resolves the identified data discrepancies according to a set of rules, and posts relevant information associated with the data discrepancy resolution to a healthcare provider information system. FIG. 1 illustrates one example of the touchless processing system in a suitable operating environment. The touchless processing system 100 may be maintained and operated by an intermediary service provider that acts as an interface between health care providers and payers to normalize communication solutions, data requirements, and transaction formats. In some embodiments, the touchless processing system 100 is maintained by the health care provider. The touchless processing system 100 communicates with a client device 122, the healthcare provider information system 126, and a payer system 140 over a computer network 102, such as the Internet.

The touchless processing system 100 includes a touchless processing engine 104 running on a computing device. The touchless processing engine 104 is in communication with one or more databases including, but not limited to, a work queue database 110, a rules database 108 and an exceptions work queue database 112. While described as separate databases, the data storage of the touchless processing system 100 may be distributed among multiple databases or consolidated in a single database.

The functionality of the touchless processing system 100 may be distributed among multiple computing devices or consolidated in a single computing device. In various embodiments, the touchless processing system 100 utilizes multiple servers with different assigned roles. For example, a highly distributed touchless processing system 100 may include a front end server (e.g., an application server or web server) that operates as the interface for communications with the health care provider, payers, and one or more transaction processing systems 118A-N (collectively 118), a database server that manages the data collected by the touchless processing system 100, and a back end server (e.g., an application server or web server) that identifies data discrepancies in patient encounter information and automatic resolves identified data discrepancies without user intervention.

In the illustrated example, the interface engine 116 receives registration data comprising patient information associated with a healthcare encounter from a client device 122 (e.g., as an EDI transaction or web service call), processes the registration data, passes selected information to one or more intermediary systems for one or more transaction processes, and receives outcomes from the transaction processes. According to an aspect, registration data specifies information such as, but not limited to, patient information, insurance information, diagnosis information, and treatment information. The patient information includes information that may be used individually or collectively to uniquely identify the patient, such as, but not limited to, name, date of birth, Social Security Number. The insurance information includes information such as, but not limited to, a payer identifier, a subscriber (i.e., patient) identifier, and a plan identifier. The diagnosis and treatment information includes information such as, but not limited to, narrative descriptions of diagnoses or treatments and diagnosis and/or treatment codes, service location (e.g., office visit or surgical visit), and service type (e.g., in-patient or out-patient). In various embodiments, diagnosis and/or treatment codes are associated with a classification, coding, or nomenclature systems for medical diagnoses and/or treatments known to the health care provider and the intermediary service provider. Examples of widely recognized systems include, but are not limited to, the International Classification of Diseases, Clinical Modification (e.g., ICD-9-CM and ICD-10-CM) and Current Procedural Terminology (CPT®).

Various aspects of the touchless processing system 100 use a combination of electronic data interchange (EDI) transactions, web services, web forms, and web pages to interactively communicate with the client device 122, the healthcare provider information system 126, and payer systems 140. Communications (i.e., messages) between the touchless processing system 100, client device 122, healthcare provider information system 126, the payer systems 140 are encrypted or otherwise secured at or above the level required to comply with applicable health care information privacy laws, regulations, and standards. The terms “request” and “response” may be used to generally describe message directionality and should not be construed as requiring any particular communication method or protocol.

EDI transactions are based on a standardized interface using strictly formatted messages representing documents that allows the healthcare provider information system 126, the touchless processing system 100 and the payer systems 140 to exchange and understand information with little to no human intervention. Human intervention in the processing of a received message is typically limited to dealing with error conditions, quality review, and other special situations. Examples of a suitable EDI health care transaction formats include, but are not limited to, HL7, 278, and X12.

Web service transactions are through an interface described in a computer readable format such as the Web Service Definition Language (WSDL) that defines the access point(s), method(s), and other specifications of the web service. The web service uses protocols such as, but not limited to, the Simple Object Access Protocol (SOAP) for communication. The messages sent and received by the web service contain the actions and corresponding information specified in the web service definition. The messages are written using use data formats such as, but not limited to, the Extensible Markup Language (XML) and the Security Assertion Markup Language (SAML). The messages are typically sent over the Internet using transport protocols such as, but not limited to, the Hypertext Transfer Protocol (HTTP), the Hypertext Transfer Protocol Secure (HTTPS), or the Simple Mail Transfer Protocol (SMTP). The web service may be a Representational State Transfer (REST) compliant service with a uniform set of methods or an arbitrary service with an arbitrary set of methods.

The interface engine 116 includes functionality to parse registration data associated with a patient encounter received from a healthcare provider into a normalized format and apply a set of rules used to determine what transaction processes are required for the encounter, for example, demographic information verification, coverage information verification, medical necessity validation, pre-certification, estimation, financial clearance, etc. The interface engine 116 populates the work queue database 110 with the parsed data, wherein the parsed registration data, the outcome data from each transaction process associated with the registration data, and other information associated with the registration data is indexed in the work queue database 110 as a patient encounter, referred to herein as an “encounter.”

The touchless processing system 100 is in communication with (or a component of) one or more transaction processing systems 118, such as a demographic information verification system, a coverage information verification system, a medical necessity validation system, a pre-certification system, an estimate system, a financial clearance system, etc. The interface engine 116 includes functionality to submit various transaction requests to the one or more intermediary systems 118 and monitor the statuses of pending requests until transaction outcomes are received.

The data comparison engine 106 includes functionality to compare the parsed data associated with an encounter against the outcomes of the one or more transaction processes to identify data discrepancies. For example, data discrepancies may include missing data or discrepancies in demographics data (e.g., name, address, social security number, date-of-birth, etc.), missing data or discrepancies in insurance data (e.g., payer identifier, subscriber (i.e., patient) identifier, plan identifier, etc.), or discrepancies in diagnosis or treatment information.

The rules database 108 comprises a set of rules used to determine whether an identified data discrepancy can be automatically resolved without user intervention based on the received outcomes. According to an aspect, the set of rules is client-configurable. For example, a healthcare provider client may configure a rule set to include a rule to default to a group number provided in a transaction response if the group number in the transaction request differs from the group number in the transaction response.

The touchless processing engine 104 includes functionality to apply the set of rules to the identified data discrepancies associated with an encounter for determining which identified data discrepancies can be automatically resolved, and to automatically resolve the data discrepancies that are able to be resolved without user intervention according to the set of rules. The touchless processing engine 104 is operable to populate the exceptions work queue 112 with encounters that are determined to comprise data discrepancies that cannot be automatically resolved. According to an aspect, a healthcare administrative user 120, herein referred to as a user 120, is enabled to access the exceptions work queue 112 via the client device 122 such as, but not limited to, a general computing device and a mobile computing device (e.g., a smart phone or tablet). The client device is generally capable of running a user agent 124 used to access the touchless processing system 100. Examples of suitable user agents include, but are not limited to, a web browser and a registration system client application compatible with the touchless processing system. The user 120 is enabled to access encounters stored in the exceptions work queue 112, view a listing of alerts associated with data discrepancies for an encounter, and address and resolve identified data discrepancies to ensure correct patient information and to ensure accurate information for downstream patient access workflow processes.

As illustrated in FIG. 1, the health care provider may also maintain a healthcare provider information system 126 running on a computing device 128. The healthcare provider information system 126 includes a database 130 storing business and patient information used by the health care provider, such as insurance information, electronic medical records, billing information, and appointments.

According to an aspect, the healthcare provider information system 126 interfaces with the touchless processing system 100. The processing engine 104 is operable to pass encounters that have been automatically resolved to the posting engine 134 for posting relevant information associated with the data discrepancy resolution and relevant information associated with transaction processing outcomes to the healthcare provider information system 126. The touchless processing system 100 is operable to automatically update patient information records stored by the healthcare provider information system 126 with information received from the payer system 140 and from the one or more transaction processing systems 118. According to an aspect, the client device 122 and the healthcare provider information system 126 are consolidated into a single computing device.

The touchless processing system 100 may be a module or component of a larger health care information system or health care management suite offered by the intermediary service provider providing functionality including, but not limited to, any or all of patient intake, patient record maintenance, insurance eligibility verification, demographic information verification, order checking, financial clearance, and claim submission. While user interactions may be described as if directly handled by the touchless processing system 100, it should be appreciated that the user interactions may actually be handled by one or more other components of the larger system at different times and the information from those user interactions are made available to the touchless processing system 100.

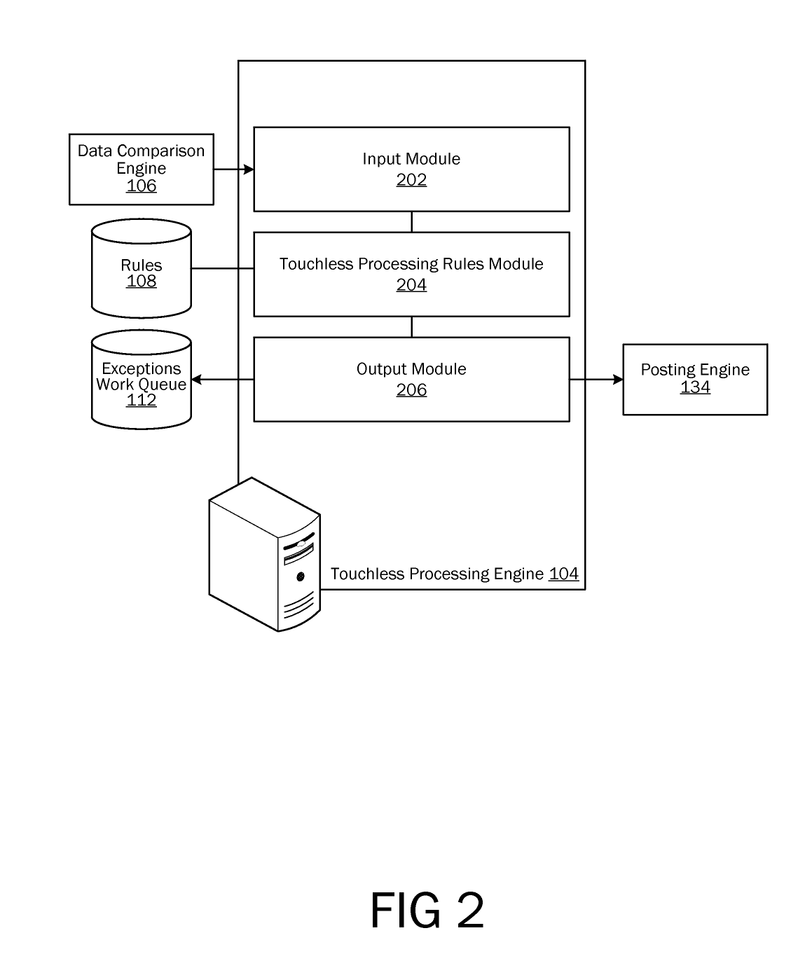

FIG. 2 is a simplified block diagram illustrating an example of components of the touchless processing engine 104. As illustrated, the touchless processing engine 104 comprises an input module 202 operable to receive identified data discrepancies associated with an encounter as determined by data comparison engine 106.

The touchless processing engine 104 further comprises a touchless processing rules module 204 in communication with the rules database 108 and operable to apply the set of rules stored in rules database 108 to the received identified data discrepancies to determine whether an identified data discrepancy can be automatically resolved without user intervention. The touchless processing rules module 204 applies the set of rules to the identified data discrepancies, and automatically resolves the data discrepancies that are determined to be resolvable without user intervention according to the set of rules.

The touchless processing engine 104 further comprises an output module 206 operable to populate the exceptions work queue 112 with encounters that are determined to comprise data discrepancies that cannot be automatically resolved according to the set of rules. The output module 206 is further operable to pass encounters that have been automatically resolved by the touchless processing engine 104 to the posting engine 134 for posting to the healthcare provider information system 126.

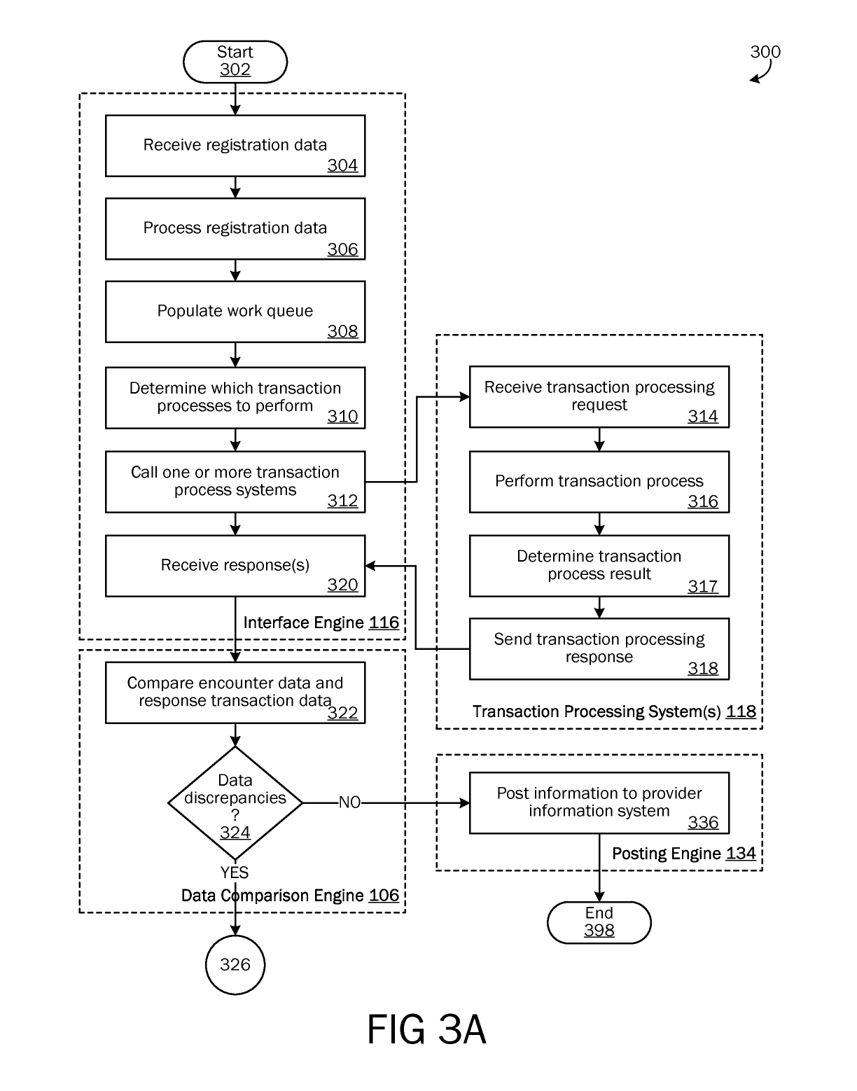

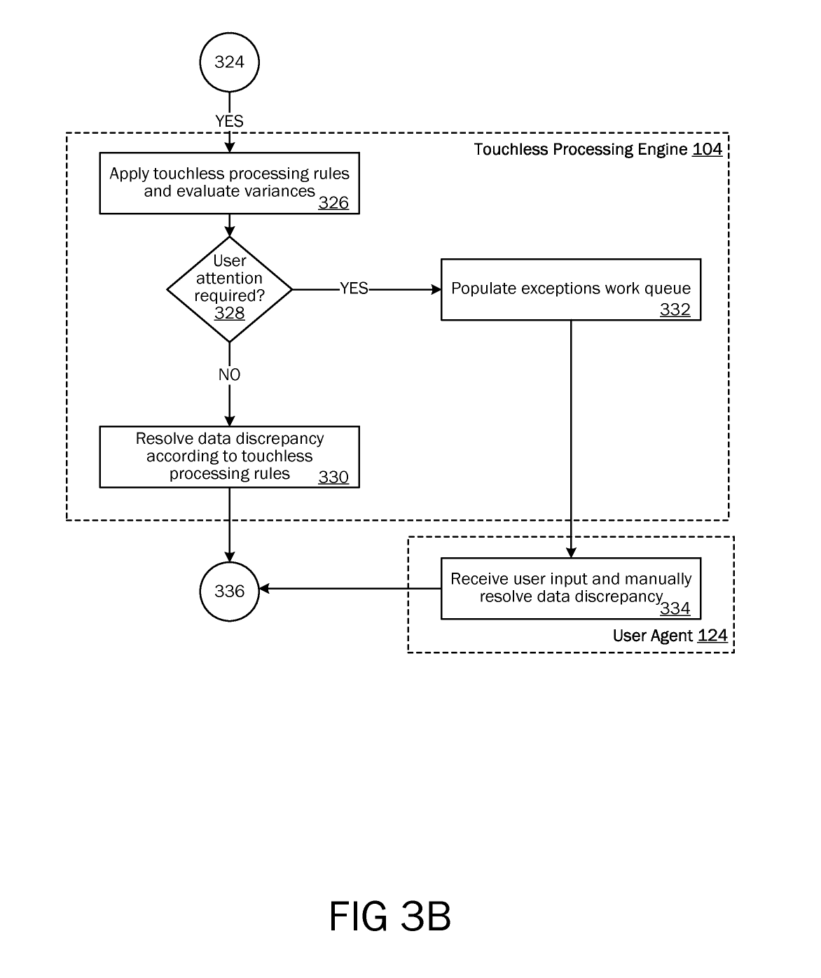

FIGS. 3A and 3B illustrate a high level flowchart of one example of a method 300 performed by the touchless processing system 100 for identifying and automatically resolving data discrepancies related to a patient encounter. The touchless processing method 300 begins at operation 302, and advances to operation 304, where the interface engine 116 receives registration data associated with a healthcare patient encounter from the health care provider. According to an aspect, the registration data is associated with providing specific healthcare services to a specific patient that may serve as the basis for an insurance claim. According to another aspect, the registration data includes one or more information requests. According to an example, the healthcare provider information system 126 displays the electronic order form, collects the information, and transmits the information to the touchless processing system 100 (e.g., as an EDI transaction or web service call). According to another example, the registration data is entered into an electronic form served from the touchless processing system 100 or another intermediary system and displayed to the user 120 on the client device 122 via the user agent 124.

The touchless processing method 300 advances to a data conversion operation 306. According to an aspect, the registration data is sent to the touchless processing system 100 in one of various EDI health care transaction formats (e.g., HL7, X12, etc.). During the data conversion operation, the interface engine 116 parses the registration data, and converts the data from the EDI health care transaction format into a universal format.

A work queue population operation 308 populates the work queue database 110 with the parsed and universally formatted registration data. According to an aspect, the work queue database 110 provides information to the health care provider about the status of a health care transaction that has been submitted to the intermediary service provider or to the payer through the intermediary service provider. The parsed and universally formatted registration data is stored as an encounter in the work queue database 110.

A rules application and data evaluation operation 310 applies a set of rules to the parsed and universally formatted registration data to determine which one or more transaction processes (e.g., demographic information verification, coverage information verification, medical necessity validation, pre-certification, payment estimation, financial clearance, etc.) to perform for the encounter. According to an aspect, the rules application and data evaluation operation makes the determination based on the message received from the healthcare provider. According to another aspect, the rules application and data evaluation operation references a master patient index and makes the determination based on historical data for the patient associated with registration data. For example, the rules application and data evaluation operation may make a determination that eligibility verification is not necessary for a given patient with historical data indicating that the patient had a healthcare encounter within the same month for which the patient's Medicaid eligibility was verified.

A transaction processing call operation 312 generates one or more requests containing selected information parsed from the registration data, and sends the one or more requests to one or more transaction processing systems 118 based on the evaluation and determination made at operation 310. For example, the transaction processing call operation 312 may generate and send a request to one or more of a demographic information verification system, a coverage information verification system, a medical necessity validation system, a pre-certification system, an estimate system, a financial clearance system, etc.

A transaction processing receipt operation 314 receives the transaction processing request and parses the request into different items of information used with the transaction processing rules. A transaction processing rule application operation 316 applies relevant transaction processing rules for performing a given transaction process based on the transaction processing request. A transaction processing result operation 317 generates a response comprising results of the transaction processing rule application operation 316. A transaction processing response operation 318 sends the response to the interface engine 116 in a format corresponding to the request format.

A transaction processing response receipt operation 320 receives the response and parses the various outcome information items from the response. A data evaluation and comparison operation 322 evaluates and compares the received outcome information from the one or more transaction processing responses with the encounter data for identifying data discrepancies between the outcome information and the encounter data.

A data discrepancy decision operation 324 makes a determination as to whether any data discrepancies were identified at operation 322. If a determination is made that one or more data discrepancies were identified, a touchless processing rules application operation 326 applies a set of touchless processing rules to the data associated with each of the identified data discrepancies to determine whether each identified data discrepancy can be automatically resolved without user intervention.

A user intervention decision operation 328 makes a determination as to whether an identified data discrepancy can be automatically resolved or whether user intervention is required according to the set of rules applied at the touchless processing rules application operation 326. If a determination is made that user intervention is not required, a data discrepancy resolution operation 330 applies the set of rules to the identified data discrepancies, and automatically resolves the data discrepancies that are determined to be resolvable without user intervention according to the set of rules.

If a determination is made that user intervention is required at the user intervention decision operation 328, an exceptions work queue population operation 332 populates the exceptions work queue 112 with encounters that are determined to comprise data discrepancies that cannot be automatically resolved according to the set of rules. The exceptions work queue population operation creates an alert associated with each of the data discrepancies for an encounter. According to an aspect, the exceptions work queue database 110 provides information to the health care provider about the status of a health care transaction that has been submitted to the intermediary service provider or to the payer through the intermediary service provider, including listing of alerts associated with data discrepancies for an encounter.

A user input receipt operation 334 receives user input associated with resolving identified data discrepancies for an encounter to ensure correct patient information and to ensure accurate information for downstream patient access workflow processes. An information posting operation 336 posts relevant information associated with the data discrepancy resolution and relevant information associated with the transaction processing outcome data to the healthcare provider information system 126. According to an aspect, the information posting operation 336 automatically updates patient information records stored by the healthcare provider information system 126 with information received from the payer system 140 and from the one or more transaction processing systems 118. The method 300 ends at operation 398.

Aspects of the present disclosure are implemented via local, remote, or a combination of local and remote computing and data storage systems. Such memory storage and processing units are implemented in a computing device, such as computing device 400. Any suitable combination of hardware, software, or firmware is used to implement the memory storage and processing unit. For example, the memory storage and processing unit is implemented with computing device 400 or any other computing devices 418, in combination with computing device 400, wherein functionality is brought together over a network in a distributed computing environment, for example, an intranet or the Internet, to perform the functions as described herein. Such systems, devices, and processors (as described herein) are examples and other systems, devices, and processors comprise the aforementioned memory storage and processing unit, consistent with embodiments of the invention.

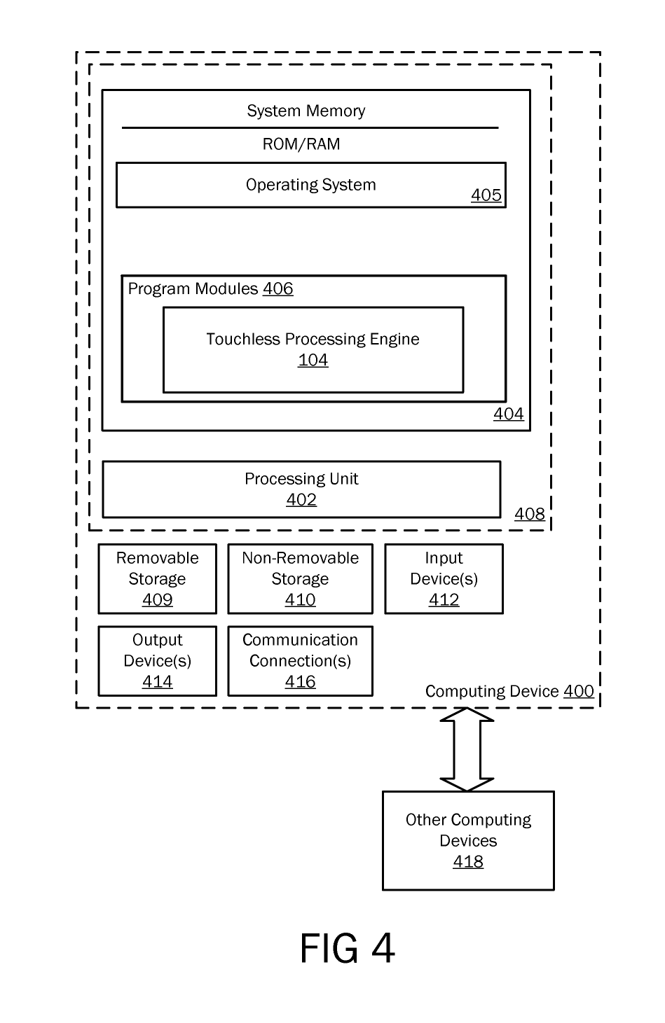

FIG. 4 illustrates one example of a computing device suitable to implement aspects of the present disclosure. The computing device 400 includes at least one processing unit 402 and a system memory 404. The system memory 404 comprises, but is not limited to, volatile (e.g. random access memory (RAM)), non-volatile (e.g. read-only memory (ROM)), flash memory, or any combination. System memory 404 includes operating system 405, one or more programming modules 406, and according to an aspect, includes the touchless processing engine 104, which when executed, performs functionalities as described herein. Operating system 405, for example, is suitable for controlling the operation of computing device 400. Furthermore, According to an aspect, features of the present disclosure are practiced in conjunction with a graphics library, other operating systems, or any other application program, and is not limited to any particular application or system. This basic configuration is illustrated by those components within a dashed line 408. According to an aspect, computing device 400 includes one or more input device(s) 412 (keyboard, mouse, pen, touch input device, etc.) and one or more output device(s) 414 (e.g., display, speakers, a printer, etc.).

According to an aspect, the computing device 400 includes additional data storage devices 409/410 (removable and/or non-removable) such as, for example, magnetic disks, optical disks, or tape. According to an aspect, computing device 400 comprises a communication connection 416 that allows device 400 to communicate with other computing devices 418, such as over a network in a distributed computing environment, for example, an intranet or the Internet. Communication connection 416 is one example of communication media.

According to an aspect, program modules, such as the touchless processing engine 104, include routines, programs, components, data structures, and other types of structures that perform particular tasks or that implement particular abstract data types. Moreover, according to an aspect, features of the present disclosure are practiced with other computer system configurations, such as hand-held devices, multiprocessor systems, microprocessor-based or programmable user electronics, minicomputers, mainframe computers, and the like. According to an aspect, features of the present disclosure are practiced in distributed computing environments where tasks are performed by remote processing devices that are linked through a communications network. In a distributed computing environment, program modules are located in both local and remote memory storage devices.

Furthermore, according to an aspect, features of the present disclosure are practiced in an electrical circuit comprising discrete electronic elements, packaged or integrated electronic chips containing logic gates, a circuit utilizing a microprocessor, or on a single chip containing electronic elements or microprocessors. According to an aspect, features of the disclosure are practiced using other technologies capable of performing logical operations such as, for example, AND, OR, and NOT, including but not limited to mechanical, optical, fluidic, and quantum technologies. According to an aspect, features of the disclosure are practiced within a general purpose computer or in any other circuits or systems.

Aspects of the present disclosure, for example, are implemented as a computer process (method), a computing system, or as an article of manufacture, such as a computer program product or computer readable media. The computer program product may be a computer storage media readable by a computer system and encoding a computer program of instructions for executing a computer process. Accordingly, the aspects of the present disclosure may be embodied in hardware and/or in software (including firmware, resident software, micro-code, etc.). In other words, aspects of the present disclosure may take the form of a computer program product on a computer-usable or computer-readable storage medium having computer-usable or computer-readable program code embodied in the medium for use by or in connection with an instruction execution system.

Although aspects of the present disclosure have been described as being associated with data stored in memory and other storage mediums, data is also storable on or readable from other types of computer-readable media, such as secondary storage devices, like hard disks, floppy disks, or a CD-ROM, or other forms of RAM or ROM. The term computer-readable storage medium refers only to devices and articles of manufacture that store data and/or computer-executable instructions readable by a computing device. Computer-readable storage media do not include communications media.

According to an aspect, features of the present disclosure are utilized in various distributed computing environments where tasks are performed by remote processing devices that are linked through a communications network.

The description and illustration of one or more aspects provided in this application are intended to provide a complete thorough and complete disclosure the full scope of the subject matter to those skilled in the art and not intended to limit or restrict the scope of the invention as claimed in any way. The aspects, examples, and details provided in this application are considered sufficient to convey possession and enable those skilled in the art to practice the best mode of claimed invention. Descriptions of structures, resources, operations, and acts considered well-known to those skilled in the art may be brief or omitted to avoid obscuring lesser known or unique aspects of the subject matter of this application. The claimed invention should not be construed as being limited to any embodiment, example, or detail provided in this application unless expressly stated herein. Regardless of whether shown or described collectively or separately, the various features (both structural and methodological) are intended to be selectively included or omitted to produce an aspect with a particular set of features. Further, any or all of the functions and acts shown or described may be performed in any order or concurrently. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

We claim:

1. A method for automatically resolving a discrepancy related to a healthcare patient encounter, the method comprising:
evaluating registration data and outcome data associated with a patient encounter for identifying discrepancies between the registration data and the outcome data associated with the patient encounter;
upon identifying one or more discrepancies between the registration data and the outcome data associated with the patient encounter, evaluating each of the one or more identified discrepancies against a set of rules indicating whether each discrepancy is able to be resolved automatically;
for each identified discrepancy that is determined to be able to be automatically resolved, applying the set of rules for automatically resolving the discrepancy; and
resolving the discrepancy.

2. The method of claim 1, further comprising posting relevant information from the discrepancy resolution to the healthcare provider information system.

3. The method of claim 1, wherein prior to evaluating the registration data and the outcome data associated with the patient encounter:
receiving, at a touchless processing system, registration data associated with the patient encounter from a healthcare provider information system; and
receiving, at the touchless processing system, outcome data associated with the patient encounter from at least one transaction processing system.

4. The method of claim 1, wherein posting relevant information from the discrepancy resolution to the healthcare provider information system comprises:
interfacing with the healthcare provider information system; and
automatically updating patient information records stored by the healthcare provider information system with updated data resulting from the discrepancy resolution.

5. The method of claim 1, wherein the set of rules are configurable by healthcare provider.

6. The method of claim 1, further comprising:
evaluating the registration data against a set of rules indicating whether one or more transaction processes are required;
upon determining one or more transaction processes are required, generating a request for each of the one or more transaction processes, wherein the request comprises relevant information from the registration data; and
sending the request to one or more transaction processing systems.

7. The method of claim 6, wherein receiving, at the touchless processing system, outcome data associated with the patient encounter from at least one transaction processing system comprises receiving a response from the one or more transaction processing systems.

8. The method of claim 6, wherein the one or more transaction processes comprise one or more of:
demographic information verification;
coverage information verification;
medical necessity validation;
pre-certification;
preauthorization;
payment estimation; or
financial clearance.

9. The method of claim 1, further comprising:
for a patient encounter comprising an identified discrepancy that is determined to not be automatically resolvable, creating an alert associated with each data discrepancy; and
populating an exceptions work queue with the patient encounter and including the at least one alert for presentation to a user.

10. The method of claim 9, further comprising:
receiving user input associated with resolving the identified data discrepancy that is determined to not be automatically resolvable; and
updating patient information records stored by the healthcare provider information system with the user input associated with resolving the identified data discrepancy.

11. A system for automatically resolving a discrepancy related to a healthcare patient encounter, the system comprising:
a rules memory storing a set of touchless processing rules;
a touchless processing engine operable to:
evaluate one or more identified discrepancies between registration data and outcome data associated with a patient encounter against the set of rules indicating whether each discrepancy is able to be resolved automatically;
for each identified discrepancy that is determined to be able to be automatically resolved, apply the set of rules for automatically resolving the discrepancy; and
resolve the discrepancy; and
a computing device having a processor and memory for storing and executing the touchless processing engine.

12. The system of claim 11, wherein the touchless processing engine is further operable to:
for a patient encounter comprising an identified discrepancy that is determined to not be automatically resolvable, create an alert associated with each data discrepancy; and
populate an exceptions work queue with the patient encounter and including the at least one alert for presentation to a user.

13. The system of claim 11, further comprising:
an interface engine operable to:
receive registration data associated with the patient encounter from a healthcare provider information system; and
receive outcome data associated with the patient encounter from at least one transaction processing system.

14. The system of claim 13, wherein the interface engine is further operable to:
evaluate the registration data against a set of rules indicating whether one or more transaction processes are required;
upon determining one or more transaction processes are required, generate a request for each of the one or more transaction processes, wherein the request comprises relevant information from the registration data; and
send the request to one or more transaction processing systems.

15. The system of claim 13, wherein the one or more transaction processing systems comprise one or more of:
a demographic information verification system;
a coverage information verification system;
a medical necessity validation system;
a pre-certification system;
a preauthorization system;
an estimate system;
a financial clearance system; or
a collections system.

16. The system of claim 11, further comprising:
a comparison engine operable to evaluate the registration data and the outcome data associated with the patient encounter for identifying discrepancies between the registration data and the outcome data associated with the patient encounter.

17. The system of claim 11, further comprising:
a posting engine operable to:
interface with the healthcare provider information system; and
automatically update patient information records stored by the healthcare provider information system with updated data resulting from the discrepancy resolution.

18. A computer readable medium containing computer executable instructions which, when executed by a computer, perform a method for automatically resolving a discrepancy related to a healthcare patient encounter, the method comprising:
receiving, at a touchless processing system, registration data associated with a patient encounter from a healthcare provider information system;
receiving, at the touchless processing system, outcome data associated with the patient encounter from at least one transaction processing system;
evaluating the registration data and the outcome data associated with a patient encounter for identifying discrepancies between the registration data and the outcome data associated with the patient encounter;
upon identifying one or more discrepancies between the registration data and the outcome data associated with the patient encounter, evaluating each of the one or more identified discrepancies against a set of rules indicating whether each discrepancy is able to be resolved automatically;
for each identified discrepancy that is determined to be able to be automatically resolved, applying the set of rules for automatically resolving the discrepancy;
resolving the discrepancy; and
posting relevant information from the discrepancy resolution to the healthcare provider information system.

19. The computer readable medium of claim 18, further comprising:
evaluating the registration data against a set of rules indicating whether one or more transaction processes are required;
upon determining one or more transaction processes are required, generating a request for each of the one or more transaction processes, wherein the request comprises relevant information from the registration data; and
sending the request to one or more transaction processing systems.

20. The computer readable medium of claim 18, further comprising:
for a patient encounter comprising an identified discrepancy that is determined to not be automatically resolvable, creating an alert associated with each data discrepancy;
populating an exceptions work queue with the patient encounter and including the at least one alert for presentation to a user;
receiving user input associated with resolving the identified data discrepancy that is determined to not be automatically resolvable; and
updating patient information records stored by the healthcare provider information system with the user input associated with resolving the identified data discrepancy.
